(19) United States
(12) Patent Application Publication
(10) Pub. No.: US 2007/0218397 A1
(43) Pub. Date: Sep. 20, 2007

(54) Production Process of Polymerized Toner

(75) Inventors: Junichi Takashima, Tokyo (JP); Kazuhiro Sato, Tokyo (JP); Yoshihiro Makuta, Tokyo (JP)

Correspondence Address: KRATZ, QUINTOS & HANSON, LLP, 1420 K Street, N.W., Suite 400, WASHINGTON, DC, 20005, US

(73) Assignee: ZEON CORPORATION, Tokyo (JP)

(21) Appl. No.: 10/594,921

(22) PCT Filed: Mar. 30, 2005
(86) PCT No.: PCT/JP05/06715

§ 371 Date: Sep. 29, 2006

(30) Foreign Application Priority Data
Mar. 31, 2004 (JP) 2004-108121

(51) Int. Cl. G03G 9/08

(52) U.S. Cl. 430/137.11; 430/137.15

(57) ABSTRACT

A production process of a polymerized toner, in which a corrosion-resistant metal container, the surface roughness Ry of an inner wall of which is at most 3 μm, is used as a polymerization container, and when an aqueous liquid dispersion is heated in the polymerization container to conduct polymerization, the temperature of the aqueous liquid dispersion is raised up to a temperature 5° C. lower than a target polymerization temperature at a heating rate of 20 to 60° C./hr and raised up to the target polymerization temperature from the temperature 5° C. lower than the target polymerization temperature at a heating rate of 5 to 30° C./hr, and after the temperature of the aqueous liquid dispersion reaches the target polymerization temperature, the polymerization is conducted while controlling the temperature of the aqueous liquid dispersion so as to fall within a range of (the target polymerization temperature ±3° C.).

### TECHNICAL FIELD

The present invention relates to a production process of a polymerized toner for developing electrostatic latent images formed by an electrophotographic process, electrostatic recording process or the like.

### BACKGROUND ART

In an image forming apparatus of the electrophotographic system or electrostatic recording system, such as copying machine, laser beam printer or facsimile, a developer is used for making an electrostatic latent image formed on a photosensitive member visible. The developer comprises, as a main component, colored resin particles with a colorant, a charge control agent, a parting agent and the like dispersed in a binder resin.

The colored resin particles are roughly divided into a pulverized toner obtained by a pulverization process and a polymerized toner obtained by a polymerization process. In the pulverization process, a binder resin, a colorant and other additive components are generally melted and kneaded, and the resultant kneaded product is pulverized and classified, thereby obtaining a pulverized toner as colored resin particles having a desired average particle diameter.

On the other hand, in the polymerization process, a polymerizable monomer composition containing, for example, a polymerizable monomer, a colorant and other additive components is polymerized in an aqueous dispersion medium, thereby obtaining a polymerized toner as colored resin particles (hereinafter referred to as “colored polymer particles”). The polymerized toner has such features as it is excellent in flowability because it is spherical, a high-quality image can be formed because its particle diameter distribution is sharp compared with the pulverized toner, and its average particle diameter can be easily controlled.

In a suspension polymerization process that is representative of the polymerization process, first of all a polymerizable monomer composition containing a polymerizable monomer and a colorant is generally added to an aqueous dispersion medium containing a dispersion stabilizer, and the resultant mixture is mixed by a mixer to form droplets of the polymerizable monomer composition. A polymerization initiator is added to the polymerizable monomer composition prior to the formation of the droplets or to the aqueous dispersion medium containing the polymerizable monomer composition during the formation of the droplets to cause the initiator to migrate into the droplets of the polymerizable monomer composition.

The aqueous dispersion medium (aqueous liquid dispersion) containing the droplets of the polymerizable monomer composition is then heated to a target polymerization temperature in a polymerization container, thereby carrying out a polymerization reaction. As the target polymerization temperature, an optimum temperature is selected according to a polymerization starting temperature, at which the polymerization initiator begins to cause thermal decomposition, polymerization reactivity of the polymerizable monomer, stability of the polymerization reaction, and so on.

As the polymerization container (also referred to as polymerization vessel, polymerization kettle, polymerization reactor or the like), is used a corrosion-resistant metal container such as a stainless steel container. A stirring device is generally arranged in the interior thereof, and a jacket capable of introducing and discharging a heat medium for temperature control is arranged on an outer peripheral wall thereof. As a method for heating the aqueous liquid dispersion in the polymerization container for conducting polymerization, the jacket temperature (heat medium temperature) of the polymerization container is set to a temperature not lower than a target polymerization temperature at an initial stage of the heating to rapidly raise the temperature of the aqueous liquid dispersion, the jacket temperature is set to a lower temperature when the temperature of the aqueous liquid dispersion comes near the target polymerization temperature, and the jacket temperature is controlled in view of even the heat of reaction so as to keep the target polymerization temperature when the temperature of the aqueous liquid dispersion reaches the target polymerization temperature.

When a polymerization reaction is conducted repeatedly by such a heating method to produce a polymerized toner, however, scale adheres to a wall surface (inner wall surface) of the polymerization container to lower the thermal conductivity of the container wall. As a result, it may be difficult in some cases to precisely control the temperature. In particular, when the heating rate is high for shortening a polymerization time (time required from the initiation of polymerization to completion of a polymerization process), the scale is easy to occur because it is necessary to heighten the jacket temperature.

In a production process of a polymerized toner, it has heretofore been proposed to use a polymerization container subjected to a glass lining treatment or TEFLON lining treatment on its inner wall for preventing adhesion of scale (Japanese Patent Application Laid-Open No. 2001-125308). When such a polymerization container subjected to the lining treatment is used, it is effective for preventing the adhesion of scale. However, the thermal conductivity of the container wall is lowered. When the thermal conductivity of the container wall is lowered, it is difficult to accelerate the heating rate or to quickly control the polymerization temperature. As a result, the polymerization time is lengthened.

In a process for producing a polymerized toner composed of colored polymer particles by suspending a polymerizable monomer composition containing at least a polymerizable monomer and a colorant in an aqueous dispersion medium containing a dispersant (also referred to as dispersion stabilizer) and polymerizing the composition with a polymerization initiator, there has been proposed a production process of a polymerized toner, in which water or the aqueous dispersion medium mixed with the dispersant is sprayed on an inner wall of a vapor phase portion in a polymerization container and/or ancillary instruments of the polymerization container (Japanese Patent Application Laid-Open No. 10-153878). When water or the aqueous dispersion medium is sprayed within the reaction container during polymerization, it is effective for preventing the adhesion of scale. However, the effect is limited to a range above the level of the aqueous liquid dispersion in the polymerization container. This process is not effective for accelerating the heating rate.

In a production process of a polymerized toner, which comprises the steps of dispersing a polymerizable monomer composition containing at least a polymerizable monomer and a colorant as droplets in an aqueous dispersion medium containing a dispersion stabilizer and then polymerizing the composition with a polymerization initiator to form colored polymer particles, there has heretofore been proposed a production process of a polymerized toner, which comprises a series of steps composed of (1) Step 1 of forming droplets of the polymerizable monomer composition containing at least the polymerizable monomer and the colorant in a first aqueous dispersion medium (A) containing the dispersion stabilizer to prepare a first aqueous liquid dispersion (B), in which the droplets are dispersed, (2) Step 2 of mixing the first aqueous liquid dispersion (B) with a second aqueous dispersion medium (C) containing 0.1 to 5% by weight of the dispersion stabilizer to prepare a second aqueous liquid dispersion (D) containing the second aqueous dispersion medium (C) in a proportion of 10 to 150 parts by weight per 100 parts by weight of the polymerizable monomer in the first aqueous liquid dispersion (B), and (3) Step 3 of polymerizing the polymerizable monomer composition dispersed as the droplets in the second aqueous liquid dispersion (D) with the polymerization initiator in a polymerization kettle to form the colored polymer particles (Japanese Patent Application Laid-Open No. 2003-287928). This process is effective for preventing the adhesion of scale, but is not effective for accelerating the heating rate.

In a production process of a polymerized toner, there has heretofore been proposed a process, in which heating is conducted under specifically controlled conditions [Japanese Patent Application Laid-Open No. 11-38675; corresponding U.S. patent (U.S. Pat. No. 5,968,705)]. Specifically, there has been proposed a production process of a polymerized toner, in which after the temperature of an aqueous liquid dispersion of a polymerizable monomer composition is raised up to a temperature 10 to 40° C. lower than a target polymerization temperature, the aqueous liquid dispersion is heated at a heating rate of 1 to 20° C./hr on the average, and then heated at a heating rate of 3 to 10° C./hr on the average after the temperature of the aqueous liquid dispersion exceeds a temperature 5° C. lower than the target polymerization temperature to polymerize the polymerizable monomer composition.

When the process that the heating rate is controlled at the time the temperature of the aqueous liquid dispersion has come near the target polymerization temperature as described above is adopted, a polymerized toner excellent in balance between storability and fixing ability and narrow in scattering of toner properties every production lot can be produced. However, this process is not sufficient in shortening of a polymerization time consisting of the sum total of a heating time (time required until reaching the target polymerization temperature from the initiation of heating) and a polymerization reaction time (time required until the polymerization is completed after reaching the target polymerization temperature) because the heating rate is relatively low, and the amount of scale to adhere is increased even under the above-described heating rate conditions when the heating rate is accelerated.

### DISCLOSURE OF THE INVENTION

It is an object of the present invention to provide a production process of a polymerized toner, by which both shortening of polymerization time and reduction in the amount of scale to adhere can be realized at the same time, and scattering of toner properties every production lot is narrow.

Another object of the present invention is to provide a production process of a polymerized toner, by which even when polymerization is continuously conducted in the same polymerization container without cleaning out adhered scale, the above-described shortened polymerization time can be kept without increasing the polymerization time, the amount of scale build-up is little, and a polymerized toner free from deterioration of toner properties can be provided.

The present inventors have carried out an extensive investigation with a view toward achieving the above objects. As a result, it has been found that the surface roughness of an inner wall of a polymerization container composed of a corrosion-resistant metal container is made small, and thermal hysteresis applied to an aqueous liquid dispersion containing droplets of a polymerizable monomer composition is devised, whereby the above objects can be achieved. The present invention has been led to completion on the basis of these findings.

According to the present invention, there is thus provided a production process of a polymerized toner, comprising Step 1 of forming droplets of a polymerizable monomer composition containing a polymerizable monomer, a colorant and a polymerization initiator in an aqueous dispersion medium containing a dispersion stabilizer to prepare an aqueous liquid dispersion with the droplets dispersed therein, and Step 2 of heating the aqueous liquid dispersion in a polymerization container to polymerize the polymerizable monomer composition, thereby forming colored polymer particles,

wherein in Step 2,

(1) a corrosion-resistant metal container, the surface roughness Ry of an inner wall of which is at most 3 μm, is used as the polymerization container, and

(2) upon the heating of the aqueous liquid dispersion in the polymerization container to conduct polymerization,

i) the temperature of the aqueous liquid dispersion is raised up to a temperature 5° C. lower than a target polymerization temperature at a heating rate of 20 to 60° C./hr,

ii) the temperature of the aqueous liquid dispersion is raised up to the target polymerization temperature from the temperature 5° C. lower than the target polymerization temperature at a heating rate of 5 to 30° C./hr, and

iii) after the temperature of the aqueous liquid dispersion reaches the target polymerization temperature, a polymerization reaction is carried out while controlling the temperature of the aqueous liquid dispersion so as to fall within a range of (the target polymerization temperature ±3° C.)

### BRIEF DESCRIPTION OF THE DRAWING

FIG. 1 illustrates an exemplary polymerization apparatus used in the production process according to the present invention.

### BEST MODE FOR CARRYING OUT THE INVENTION

In the production process according to the present invention, droplets of a polymerizable monomer composition containing at least a polymerizable monomer, a colorant and a polymerization initiator are formed in an aqueous dispersion medium containing a dispersion stabilizer to prepare an aqueous liquid dispersion with the droplets dispersed therein. The polymerizable monomer used in the present invention is that containing a monovinyl monomer as a main component. The polymerizable monomer will become a binder resin in colored polymer particles by polymerization.

Specific examples of the monovinyl monomer include styrene monomers such as styrene, 4-methylstyrene and α-methylstyrene; unsaturated carboxylic acid monomers such as acrylic acid and methacrylic acid; unsaturated carboxylic acid ester monomers such as methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate and dimethylaminoethyl methacrylate; unsaturated carboxylic acid derivatives such as acrylonitrile, methacrylonitrile, acrylamide and methacrylamide; ethylenically unsaturated monoolefins such as ethylene, propylene and butylene; vinyl halide monomers such as vinyl chloride, vinylidene chloride and vinyl fluoride; vinyl esters such as vinyl acetate and vinyl propionate; vinyl ethers such as vinyl methyl ether and vinyl ethyl ether; vinyl ketone monomers such as vinyl methyl ketone and methyl isopropenyl ketone; and nitrogen-containing vinyl monomers such as 2-vinylpyridine, 4-vinyl-pyridine and N-vinylpyrrolidone.

These monovinyl monomers may be used either singly or in any combination thereof. Among these monovinyl monomers, the styrene monomers, unsaturated carboxylic acid monomers, unsaturated carboxylic acid esters and unsaturated carboxylic acid derivatives are preferred, with the styrene monomers and ethylenically unsaturated carboxylic acid esters being particularly preferred.

When an optional crosslinkable monomer is used as a polymerizable monomer together with these monovinyl monomers, the fixing ability and particularly offset property of the resulting toner are improved. Examples of the crosslinkable monomer include aromatic divinyl compounds such as divinylbenzene, divinylnaphthalene and derivatives thereof; polyfunctional ethylenically unsaturated carboxylic acid esters such as ethylene glycol dimethacrylate and diethylene glycol dimethacrylate; N,N-divinylaniline; divinyl ether; and compounds having three or more vinyl groups. These crosslinkable monomers may be used either singly or in any combination thereof. In the present invention, the crosslinkable monomer is desirably used in a proportion of generally 0.05 to 5 parts by weight, preferably 0.1 to 2 parts by weight per 100 parts by weight of the monovinyl monomer.

In the present invention, a macromonomer may be additionally used as a polymerizable monomer. The macromonomer is a macromolecule having a polymerizable vinyl functional group at its molecular chain terminal and is an oligomer or polymer having a number average molecular weight of generally 1,000 to 30,000. As examples of the polymerizable vinyl functional group that the macromonomer has at its molecular chain terminal, may be mentioned an acryloyl group and a methacryloyl group. Among these, the methacryloyl group is preferred from the viewpoint of easy copolymerization. The macromonomer is used in proportion of generally 0.01 to 10 parts by weight, preferably 0.03 to 5 parts by weight, more preferably 0.05 to 1 part by weight per 100 parts by weight of the monovinyl monomer. When the proportion of the macromonomer used falls within the above range, a polymerized toner well balanced between storability and fixing ability can be provided.

As the colorant, may be generally used any of dyes and pigments well known as colorants for toners. As examples of black colorants, may be mentioned dyes and pigments such as carbon black and Nigrosine Base; and magnetic powders such as cobalt, nickel, triiron tetroxide, manganese iron oxide, zinc iron oxide and nickel iron oxide. When carbon black is used, that having a primary particle diameter ranging from 20 to 40 nm is preferably used in that the safety of a working environment upon preparation of a toner is enhanced, and the resulting toner can provide images good in image quality.

Colorants for color toners such as a yellow toner, a magenta toner and a cyan toner include yellow colorants, magenta colorants and cyan colorants, respectively. As the yellow colorants, may be used compounds such as azo pigments and fused polycyclic pigments. Specific examples thereof include C.I. Pigment Yellow 3, 12, 13, 14, 15, 17, 62, 65, 73, 74, 83, 90, 93, 97, 120, 138, 155, 180 and 181.

As the magenta colorants, may be used compounds such as azo pigments and fused polycyclic pigments. Specific examples thereof include C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209 and 251; and C.I. Pigment Violet 19.

As the cyan colorants, may be used copper phthalocyanine compounds and derivatives thereof, anthraquinone compounds, and the like. Specific examples thereof include C.I. Pigment Blue 2, 3, 6, 15, 15:1, 15:2, 15:3, 15:4, 16, 17 and 60.

These colorants are each used in a proportion of generally 0.1 to 50 parts by weight, preferably 1 to 20 parts by weight per 100 parts by weight of the polymerizable monomer. These colorants may be used either singly or in any combination thereof.

As the charge control agent, may be used various kinds of charge control agents having positively charging ability or negatively charging ability. Examples thereof include metal complexes of organic compounds having a carboxyl group or a nitrogen-containing group, metallized dyes, nigrosine and charge control resins. More specifically, for example, charge control agents such as SPIRON BLACK TRH (product of Hodogaya Chemical Co., Ltd.), T-77 (product of Hodogaya Chemical Co., Ltd.), BONTRON S-34 (product of Orient Chemical Industries Ltd.), BONTRON E-84 (product of Orient Chemical Industries Ltd.), BONTRON N-01 (product of Orient Chemical Industries Ltd.) and COPY BLUE-PR (product of Clariant Co.); and charge control resins such as quaternary ammonium group-containing copolymers or salts thereof, and sulfonic group-containing copolymers or salts thereof may be used. The charge control agent is used in a proportion of generally 0.01 to 10 parts by weight, preferably 0.03 to 8 parts by weight per 100 parts by weight of the polymerizable monomer.

Other additives such as a parting agent, a molecular weight modifier and a polymerization initiator may be contained in the polymerizable monomer composition as needed.

As examples of the parting agent, may be mentioned low molecular weight polyolefin waxes such as low molecular weight polyethylene, low molecular weight polypropylene and low molecular weight polybutylene; terminal-modified polyolefin waxes such as molecular terminal-oxidized low molecular weight polypropylene, terminal-modified low molecular weight polypropylene whose molecular terminal is substituted by an epoxy group, block copolymers of these compounds with low molecular weight polyethylene, molecular terminal-oxidized low molecular weight polyethylene, low molecular weight polyethylene whose molecular terminal is substituted by an epoxy group, and block copolymers of these compounds with low molecular weight polypropylene; vegetable waxes such as candelilla wax, carnauba wax, rice wax, Japan wax and jojoba wax; petroleum waxes such as paraffin wax, microcrystalline wax and petrolatum, and modified waxes thereof; mineral waxes such as montan, ceresin and ozokerite; synthetic waxes such as Fischer-Tropsch wax; and polyfunctional ester compounds, such as pentaerythritol esters such as pentaerythritol tetramyristate, pentaerythritol tetrapalmitate and pentaerythritol tetralaurate, and dipentaerythritol esters such as dipentaerythritol hexamyristate, dipentaerythritol hexapalmitate and dipentaerythritol hexylaurate. These parting agents may be used either singly or in any combination thereof.

Among these parting agents, the synthetic waxes, terminal-modified polyolefin waxes, petroleum waxes, modified petroleum waxes and polyfunctional ester compounds are preferred, and the polyfunctional ester compounds are more preferred. Among the polyfunctional ester compounds, polyhydric alcohol esters, such as pentaerythritol esters, whose endothermic peak temperatures fall within a range of generally 30 to 200° C., preferably 50 to 180° C., more preferably 60 to 160° C. as determined from a DSC curve upon heating thereof by a differential scanning calorimeter (DSC), and dipentaerythritol esters, whose endothermic peak temperatures fall within a range of 50 to 80° C. as determined likewise, are desirable from the viewpoint of a balance between the fixing ability and the parting property of the resulting toner. Among other, dipentaerythritol esters having a molecular weight of at least 1,000, a solubility of at least 5 parts by weight in 100 parts by weight of styrene at 25° C. and an acid value of at most 10 mg/KOH are particularly preferred because they can markedly contribute to lowering of the fixing temperature of the resulting toner. The endothermic peak temperature is a value measured in accordance with ASTM D 3418-82. The parting agent is used in a proportion of generally 0.1 to 30 parts by weight, preferably 1 to 20 parts by weight per 100 parts by weight of the polymerizable monomer.

As examples of the molecular weight modifier, may be mentioned mercaptans such as t-dodecylmercaptan, n-dodecylmercaptan and n-octylmercaptan; and halogenated hydrocarbons such as carbon tetrachloride and carbon tetrabromide. These molecular weight modifiers may be contained in either the polymerizable monomer composition or the aqueous liquid dispersion with the droplets formed therein in the polymerization container before the initiation of the polymerization or in the course of the polymerization. The molecular weight modifier is used in a proportion of generally 0.01 to 10 parts by weight, preferably 0.1 to 5 parts by weight per 100 parts by weight of the polymerizable monomer.

As examples of the polymerization initiator, may be mentioned persulfates such as potassium persulfate and ammonium persulfate; azo compounds such as 4,4′-azobis(4-cyanovaleric acid), 2,2′-azobis(2-amidinopropane) dihydrochloride, 2,2′-azobis-2-methyl-N-1,1′-bis(hydroxymethyl)-2-hydroxyethylpropionamide, 2,2′-azobis(2,4-dimethylvaleronitrile), 2,2′-azobis-isobutyronitrile and 1,1′-azobis(1-cyclohexanecarbonitrile); and peroxides such as methyl ethyl peroxide, di-t-butyl peroxide, acetyl peroxide, dicumyl peroxide, lauroyl peroxide, benzoyl peroxide, t-butyl peroxy-2-ethylhexanoate, t-butyl perbutylneodecanoate, t-hexyl peroxy-2-ethylhexanoate, t-butyl peroxypivalate, t-hexyl peroxypivalate, di-isopropyl peroxydicarbonate, di-t-butyl peroxyisophthalate, 1,1′,3,3′-tetramethylbutyl peroxy-2-ethylhexanoate and t-butyl peroxyisobutyrate. Redox initiators obtained by combining these polymerization initiators with a reducing agent may also be used.

Among these polymerization initiators, an oil-soluble polymerization initiator, which is soluble in a polymerizable monomer used, is preferably selected, and a water-soluble polymerization initiator may also be used in combination with such an initiator as needed. The polymerization initiator is used in a proportion of generally 0.1 to 20 parts by weight, preferably 0.3 to 15 parts by weight, more preferably 0.5 to 10 parts by weight per 100 parts by weight of the polymerizable monomer. The polymerization initiator may be added into the polymerizable monomer composition in advance. In order to avoid the progress of polymerization during the formation of the droplets, however, the polymerization initiator is preferably added into the aqueous liquid dispersion in the course of the formation of the droplets to cause it to migrate into the droplets.

The aqueous dispersion medium is a dispersion medium comprising water as a main component, and a dispersion stabilizer is preferably contained in this medium. As examples of the dispersion stabilizer, may be mentioned sulfates such as barium sulfate and calcium sulfate; carbonates such as barium carbonate, calcium carbonate and magnesium carbonate; phosphates such as calcium phosphate; metal oxides such as aluminum oxide and titanium oxide; metal hydroxides such as aluminum hydroxide, magnesium hydroxide and ferric hydroxide; water-soluble polymers such as polyvinyl alcohol, methyl cellulose and gelatin; and anionic surfactants, nonionic surfactants and amphoteric surfactants. Among these dispersion stabilizers, colloid of a metallic compound, particularly, a hardly water-soluble metal hydroxide is preferred because the particle diameter distribution of colored polymer particles to be formed can be narrowed, and the brightness or vividness of the resulting image is improved.

The colloid of the hardly water-soluble metal hydroxide is not limited by the production process thereof. However, colloid of a hardly water-soluble metal hydroxide obtained by adjusting the pH of an aqueous solution of a water-soluble polyvalent metal compound to 7 or higher, particularly, colloid of a hardly water-soluble metal hydroxide formed by reacting a water-soluble polyvalent metal compound with an alkali metal hydroxide salt in an aqueous phase is preferred as the dispersion stabilizer.

The colloid of the hardly water-soluble metallic compound preferably has number particle diameter distributions, D₅₀ (50% cumulative value of number particle diameter distribution) of at most 0.5 μm and D₉₀ (90% cumulative value of number particle diameter distribution) of at most 1 μm. If the particle diameter of the colloid is too great, the polymerization is easy to be unstable, and the storability of the resulting polymerized toner is deteriorated.

The dispersion stabilizer is used in a proportion of generally 0.1 to 20 parts by weight, preferably 0.3 to 10 parts by weight per 100 parts by weight of the polymerizable monomer. If this proportion is too low, it is difficult to achieve sufficient polymerization stability, so that polymer aggregates are liable to form. If this proportion is too high on the other hand, the resulting polymerized toner particles become too fine. It is hence not preferable to use the dispersion stabilizer in such a too low or high proportion.

The aqueous dispersion medium used in the present invention may contain a water-soluble organic compound or inorganic compound in addition to the dispersion stabilizer. Among water-soluble organic compounds or inorganic compounds, water-soluble oxoacid salts are preferred because the particle diameter distribution of the resulting polymerized toner becomes sharp. Examples of the water-soluble oxoacid salts include boric acid salts, phosphoric acid salts, sulfuric acid salts, carbonic acid salts, silicic acid salts and nitric acid salts. Among these, the boric acid salts and phosphoric acid salts are preferred, and the boric acid salts are more preferred.

Examples of the boric acid salts include sodium tetrahydroborate, potassium tetrahydroborate, sodium tetraborate, sodium tetraborate decahydrate, sodium metaborate, sodium metaborate tetrahydrate, sodium peroxoborate tetrahydrate, potassium metaborate and potassium tetraborate octahydrate. Examples of the phosphoric acid salts include sodium phosphinate monohydrate, sodium phosphonate pentahydrate, sodium hydrogenphosphonate heptahydrate, sodium phosphate dodecahydrate, disodium hydrogenphosphate, disodium hydrogenphosphate dodecahydrate, sodium dihydrogenphosphate monohydrate, sodium dihydrogenphosphate dihydrate, sodium hexametaphosphate, sodium hypophosphate decahydrate, sodium diphosphate decahydrate, disodium dihydrogendiphosphate, disodium dihydrogendiphosphate hexahydrate, sodium triphosphate, sodium cyclotetraphosphate, potassium phosphinate, potassium phosphonate, potassium hydrogenphosphonate, potassium phosphate, dipotassium hydrogenphosphate, potassium dihydrogenphosphate, potassium diphosphate trihydrate and potassium metaphosphate. The water-soluble oxoacid salt is used in a proportion of generally 0.1 to 1,000 parts by weight, preferably 1 to 100 parts by weight per 100 parts by weight of the colloid of the hardly water-soluble inorganic compound.

In the present invention, droplets of the polymerizable monomer composition containing the polymerizable monomer, colorant and polymerization initiator are formed in the aqueous dispersion medium containing the dispersion stabilizer to prepare an aqueous liquid dispersion with the droplets dispersed therein. The polymerizable monomer composition prior to the formation of the droplets is prepared by mixing the polymerizable monomer, the colorant and other additives by a mixer and, as needed, subjecting the resultant mixture to wet grinding by means of a media type wet grinding machine (for example, a bead mill).

The polymerizable monomer composition is then poured into the aqueous dispersion medium containing the dispersion stabilizer, and the resultant mixture is stirred to form uniform primary droplets of the polymerizable monomer composition. In this step, primary droplets having a volume average droplet diameter of 50 to 1,000 μm, preferably 100 to 500 μm are generally formed. In order to avoid progress of polymerization during the formation of the droplets, it is preferable to add the polymerization initiator to the aqueous dispersion medium after the size of the primary droplets in the aqueous dispersion medium becomes uniform to cause it to migrate into the primary droplets. Accordingly, in the present invention, to form the droplets of the polymerizable monomer composition containing the polymerizable monomer, colorant and polymerization initiator in the aqueous dispersion medium containing the dispersion stabilizer includes a case where a polymerizable monomer composition containing the polymerizable monomer and colorant and containing no polymerization initiator is used to start the formation of droplets, and the polymerization initiator is added in the course of the formation of the droplets to cause it to migrate into the droplets, thereby forming droplets of a polymerizable monomer composition containing the polymerization initiator.

The aqueous liquid dispersion with the primary droplets of the polymerizable monomer composition dispersed in the aqueous dispersion medium is further stirred by means of a high-speed rotation shearing type agitator until the droplet diameter of the droplets becomes a fine droplet diameter near the intended polymerized toner particles. In such a manner, finer droplets (secondary droplets) are formed. In this droplet-forming step (preparation step 1 of aqueous liquid dispersion containing droplets), secondary droplets having a volume average droplet diameter of about 1 to 12 μm are generally formed.

The volume average droplet diameter of the droplets of the polymerizable monomer composition is generally 1 to 12 μm, preferably 2 to 10 μm, more preferably 3 to 9 μm. When a polymerized toner having a relatively great particle diameter is produced, the upper limit of the volume average droplet diameter of droplets may also be determined to be about 30 μm or 50 μm. When a polymerized toner having a particularly small particle diameter is produced for the purpose of obtaining a high-definition image, however, it is desirable that the volume average droplet diameter of the droplets be made small. The droplet diameter distribution (volume average droplet diameter/number average droplet diameter ratio) of the droplets of the polymerizable monomer composition is generally 1 to 3, preferably 1 to 2.5, more preferably 1 to 2. When particularly fine droplets are formed, it is preferable to pass the aqueous dispersion medium containing the monomer composition through between a rotor, which rotates on its axis at high speed, and a stator surrounding it and having small openings or comb-like teeth.

The aqueous liquid dispersion containing the droplets of the polymerizable monomer composition may be either prepared in a polymerization container or prepared in a separate container and then poured into the polymerization container. However, the latter method is preferred. The aqueous liquid dispersion containing the droplets of the polymerizable monomer composition is heated to a temperature of 35 to 95° C. in the polymerization container to conduct polymerization. If the polymerization temperature is too low, it is difficult to control the polymerization reaction because a polymerization initiator having high catalytic activity must be used. If the polymerization temperature is too high, an additive melting at a low temperature, if contained, bleeds at the surface of the resulting polymerized toner, so that the storability of the polymerized toner may be deteriorated in some cases.

In the present invention, a corrosion-resistant metal container is used as the polymerization container. As the corrosion-resistant metal, is preferred stainless steel. The stainless steel is a generic name of alloy steel containing at least 10.5% of chromium. The stainless steel is hard to cause rust that is the greatest weak point of iron, excellent in corrosion resistance, durability, design property, fire resistance, low temperature property and processability and easy to be maintained.

When chromium is added into iron, the chromium is bonded to oxygen to form a thin protective film (passive state film) on the surface of the steel. This passive state film prevents progress of rust and stain. This passive state film is as thin as about three millionth millimeter, but is very tough and has a function of reproduce it even when it is broken once so far as oxygen is present there.

According to Japanese Industrial Standards (JIS), stainless steel is classified into two great groups of #400 series and #300 series. The stainless steel of the #400 series is alloy steel composed of iron and chromium, while the stainless steel of the #300 series is alloy steel composed of iron, chromium and nickel. Among these, the stainless steel of the #300 series is particularly preferred because it is excellent in ductility, malleability, toughness, processability, weldability and corrosion resistance, and adhesion of scale is hard to occur when it is used as a polymer container for production of a polymerized toner.

Examples of the stainless steel (austenitic stainless steel) of the #300 series include SUS301, SUS302, SUS303, SUS304L, SUS304J1, SUS305, SUS309S, SUS316 and SUS321. among these, SUS304L is preferred from the viewpoint of corrosion resistance.

In the present invention, a corrosion-resistant metal container, the surface roughness Ry of an inner wall of which is at most 3 μm, preferably at most 1 μm, more preferably at most 0.5 μm, is used as the polymerization container. The surface roughness Ry is prescribed in JIS B 0601 and means a value obtained by drawing only a reference length out of a roughness curve in a direction of a mean line, measuring an interval between a crest line and a root line of this drawn out portion in a direction of a longitudinal magnification of the roughness curve, and expressing this value by μm.

In order to make the surface roughness Ry of the inner wall of the polymerization container small to at most 3 μm, it is preferable to polish the inner wall by buff polishing, electrolytic polishing or a polishing method by a combination of buff polishing and electrolytic polishing. The buff polishing is a sort of mechanical polishing and is a method that a buff abrasive is attached to a brush or a fabric-made polishing wheel to conduct polishing. It is preferable that the roughness of the buff abrasive be initially made coarse and gradually made fine with the progress of polishing to continue the polishing.

In order to make the surface roughness Ry of the inner wall of the polymerization container small to at most 0.5 μm, it is preferable that the buff polishing be conducted, and the polishing be changed over to electrolytic polishing at the time the average value of the surface roughness has reached 0.5 μm. The electrolytic polishing is a polishing method making use of a phenomenon that a metal sample to be polished is used as a positive electrode to cause electricity to flow through it in a corrosive solution (electrolytic polishing solution), whereby fine convex portions on the surface of the metal are predominantly dissolved to obtain a smooth and bright surface.

In the electrolytic polishing, planarization and brightening of a polished surface can be generally achieved at the same time while causing electricity to flow through the metal sample in the electrolytic polishing solution containing a strong acid or strong alkali at a relatively high concentration. In the mechanical polishing, planarization and brightening are conducted by machining the surface of a metal to plastically deform it. In comparison with this mechanical polishing, the electrolytic polishing is excellent in working effects such as improvement of beauty, improvement of corrosion resistance, improvement of anti-adhesion property and improvement of cleaning property.

When the stainless steel is subjected to electrolytic polishing, an oxide film is formed in addition to the planarization of irregularities of the surface and brightening of the surface. In addition, iron is more predominantly dissolved out than chromium by the electrolytic polishing, and chromium is left on the surface in a concentrated state, so that a uniform passive state film is formed on the polished surface, whereby corrosion resistance is improved, and moreover gloss (brightness) can be sustained. The electrolytic polishing is suitable for fine planarization. In order to remove irregularities having a width of several μm or greater, it is desirable that after these irregularities are removed in advance by mechanical polishing such as buff polishing, the electrolytic polishing be carried out.

In the present invention, after Step 1 of preparing the aqueous liquid dispersion with the droplets of the polymerizable monomer composition dispersed therein, colored polymer particles are formed by Step 2 of heating the aqueous liquid dispersion in the polymerization container to polymerize the polymerizable monomer composition. In Step 2, the temperature is raised stepwise in accordance with the following procedure.

i) The temperature of the aqueous liquid dispersion is raised up to a temperature 5° C. lower than a target polymerization temperature at a heating rate of 20 to 60° C./hr.

ii) The temperature of the aqueous liquid dispersion is raised up to the target polymerization temperature from the temperature 5° C. lower than the target polymerization temperature at a heating rate of 5 to 30° C./hr.

iii) After the temperature of the aqueous liquid dispersion reaches the target polymerization temperature, the polymerization is carried out while controlling the temperature of the aqueous liquid dispersion so as to fall within the range of ±3° C. from the target polymerization temperature.

The temperature of the aqueous liquid dispersion prior to initiation of the polymerization including the step of forming the droplets is controlled within a range of generally 10 to 40° C., preferably 20 to 30° C. If this temperature is too high, a polymerization reaction is partially initiated in the aqueous liquid dispersion, so that it is difficult to obtain homogenous colored polymer particles or to control the polymerization reaction due to progress of polymerization during the formation of droplets. If this temperature is too low, the flowability of the aqueous liquid dispersion is lowered, so that it is difficult to form droplets having a fine droplet diameter.

In the present invention, the temperature of the aqueous liquid dispersion is raised up to the temperature 5° C. lower than the target polymerization temperature at a heating rate of 20 to 60° C./hr, preferably 25 to 50° C./hr. According to the production process of the present invention, the heating rate at this stage can be accelerated. Japanese Patent Application Laid-Open No. 11-38675 (corresponding to U.S. Pat. No. 5,968,705) describes the fact that after an aqueous liquid dispersion containing droplets of a polymerizable monomer composition is heated, and the temperature thereof reaches a temperature 10 to 40° C. lower than a target polymerization temperature, the aqueous liquid dispersion is heated up to a temperature 5° C. lower than the target polymerization temperature at a heating rate of 1 to 20° C./hr on the average. Example thereof shows that the temperature was raised at a heating rate of 10° C./hr.

As described above, in the production process of the present invention, the temperature of the aqueous liquid dispersion can be raised up to the temperature 5° C. lower than the target polymerization temperature at a heating rate as fast as 20 to 60° C./hr, preferably 25 to 50° C./hr, so that the polymerization time can be greatly shortened.

In the present invention, the temperature of the aqueous liquid dispersion is raised up to the target polymerization temperature from the temperature 5° C. lower than the target polymerization temperature at a heating rate of 5 to 30° C./hr, preferably 10 to 20° C./hr. Japanese Patent Application Laid-Open No. 11-38675 (corresponding to U.S. Pat. No. 5,968,705) describes the fact that the aqueous liquid dispersion is heated at a heating rate of 3 to 10° C./hr on the average after the temperature of the aqueous liquid dispersion exceeds the temperature 5° C. lower than the target polymerization temperature, and Example thereof shows that the temperature was raised at a heating rate of 7° C./hr. According to the present invention, the heating rate at this stage can be accelerated.

In the present invention, finally, after the temperature of the aqueous liquid dispersion reaches the target polymerization temperature, the polymerization reaction is continued while controlling the temperature of the aqueous liquid dispersion, in which the polymerization reaction has been initiated, so as to fall within the range of ±3° C. from the target polymerization temperature. The polymerization reaction is often initiated right before the temperature of the aqueous liquid dispersion reaches the target polymerization temperature.

In the present invention, the target polymerization temperature means a mean temperature in the latter half (after the heating) of the time required until after the heating of the aqueous liquid dispersion containing the droplets of the polymerizable monomer composition is initiated, the formation of the colored polymer particles (core particles in the case of core•shell type colored polymer particles) is completed by polymerization. The target polymerization temperature is preferably controlled to an optimum polymerization temperature selected according to the thermal decomposition temperature of the polymerization initiator used, the polymerization reactivity of the polymerizable monomer used, the stability of the polymerization reaction during the polymerization, etc. Such a target polymerization temperature is generally used in the art. In the present invention, however, it is preferably determined to be within the range of ±2° C. from hourly half-life temperature.

In order to control the heating rate of the aqueous liquid dispersion and keep the target polymerization temperature, it is preferable to adopt a method, in which a temperature of the aqueous liquid dispersion in the polymerization container is measured, and a jacket temperature is controlled on the basis of this measured value. As examples of a method for controlling the temperature, may be mentioned a feedback control method making use of control algorism such as cascade control, P control, PI control, PID control, optimal control or fuggy control, and a feedforward control method.

For example, in the cascade control, the jacket temperature is set higher than the target polymerization temperature until the temperature of the aqueous liquid dispersion reaches the target polymerization temperature, thereby raising the temperature of the aqueous liquid dispersion at a fast heating rate. After the temperature of the aqueous liquid dispersion reaches the target polymerization temperature, the jacket temperature is frequently varied up and down in view of the heat of reaction generated to control it so as to keep the temperature of the aqueous liquid dispersion constant.

The polymerization step is completed at the time a desired conversion into a polymer has been achieved, and generally completed at the time the conversion into the polymer has reached substantially 100% (at least 99%). According to the process of the present invention, it is hared for scale to adhere to the inner wall of the polymerization container even when the heating rate is accelerated, so that a polymerized toner free from scattering of toner properties can be provided even when the polymerization container is used repeatedly as it is without cleaning out adhered scale to make the same temperature control as described above. According to the present invention, high-quality colored polymer particles can be efficiently and stably produced by the above Steps 1 and 2.

In the production process according to the present invention, the processes disclosed in Japanese Patent Application Laid-Open No. 10-153878 and Japanese Patent Application Laid-Open No. 2003-287928 may be additionally adopted.

For example, in accordance with the process disclosed in Japanese Patent Application Laid-Open No. 2003-287928, a process, in which in Step 1, droplets of a polymerizable monomer composition containing a polymerizable monomer, a colorant and a polymerization initiator are formed in a first aqueous dispersion medium (A1) containing a dispersion stabilizer to prepare an aqueous liquid dispersion with the droplets dispersed therein, and upon pouring of the aqueous liquid dispersion into a polymerization container in Step 2, the aqueous liquid dispersion is poured into the polymerization container, into which a second aqueous dispersion medium (A2) containing 0.1 to 5% by weight of the dispersion stabilizer has been poured in a proportion of 10 to 150 parts by weight per 100 parts by weight of the polymerizable monomer, may be adopted.

When the process disclosed in Japanese Patent Application Laid-Open No. 2003-287928 is adopted, stable polymerization operation becomes feasible on an industrial scale without impairing the stability of the droplets of the polymerizable monomer composition, and the occurrence of scale in the polymerization container can be markedly inhibited.

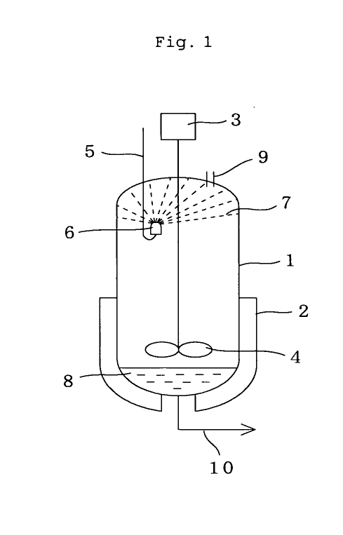

FIG. 1 is a cross-sectional view of a polymerization container. A jacket 2 for temperature control, a motor 3 for rotating an agitating blade, the agitating blade 4, an input port 9 for an aqueous liquid dispersion containing droplets of a polymerizable monomer composition, a discharge pipe 10 for discharging a reaction solution (slurry) or the like, and the like are arranged at the polymerization container 1. A heat medium (including a refrigerant) is passed through the jacket to control the temperature within the polymerization container. As the heat medium, is preferred hot water. A shower nozzle 6 is arranged within the polymerization container 1 in such a manner that a second aqueous dispersion medium (A2) from a pipe 5 can be sprayed within the polymerization container 1.

The second aqueous dispersion medium (A2) is preferably poured while being sprayed on the inner wall of the polymerization container 1 or the agitating blade 4 or both thereof from the shower nozzle 6. In FIG. 1, a sprayed liquid 7 is sprayed toward an upper portion (vapor phase portion) of the polymerization container 1 to wet the inner wall of the upper portion. However, the direction of the spraying may be changed to a direction of the inner wall or agitating blade. According to the spraying direction shown in FIG. 1, the second aqueous dispersion medium (A2) sprayed on the inner wall of the upper portion soon reaches a lower portion along the inner wall. In such a manner, the inner wall of the polymerization container, the agitating blade and the like are wetted by the second aqueous dispersion medium (A2), the adhesion of scale to the inner wall of the polymerization container can be effectively inhibited.

In production process of the present invention, the second aqueous dispersion medium (A2) sprayed and poured into the polymerization container 1 is preferably left at the lower portion of the polymerization container 1 as it is. The second aqueous dispersion medium (A2) 8 left at the lower portion of the polymerization container 1 lightens shock by falling when the aqueous liquid dispersion containing the droplets of the polymerizable monomer composition is poured into the polymerization container from, for example, the input port 9. Unless the second aqueous dispersion medium (A2) is left at the lower portion of the polymerization container 1, the aqueous liquid dispersion directly collides with the bottom of the polymerization container, so that undesirable phenomena such as union and breakdown of the droplets are easy to occur.

In order to leave the second aqueous dispersion medium (A2) at the lower portion of the polymerization container, it is necessary to control the amount of the aqueous dispersion medium poured. The mere spraying of a small amount of the second aqueous dispersion medium (A2) is difficult to leave the second aqueous dispersion medium (A2) at the lower portion of the polymerization container in an amount sufficient to lighten the shock upon pouring of the aqueous liquid dispersion. It is thus preferable to use the second aqueous dispersion medium (A2) in a proportion of 10 to 150 parts by weight per 100 parts by weight of the polymerizable monomer. This proportion is preferably 15 to 130 parts by weight, more preferably 20 to 100 parts by weight.

On the other hand, in accordance with the process disclosed in Japanese Patent Application Laid-Open No. 10-153878, a process, in which in Step 2, water is sprayed during a polymerization reaction to retain an upper inner wall surface of a polymerization container in a wetted state, may be adopted. The spraying of water permits preventing the adhesion of scale to the upper inner wall of the aqueous liquid dispersion (reaction liquid) and ancillary instruments. The spraying of water can be carried out by means of the shower nozzle 6 shown in FIG. 1.

After the colored polymer particles are obtained by the above Step 2, the colored polymer particles are used as core particles, and the surfaces thereof are further covered with a polymer (polymer for shell), whereby core-shell type colored polymer particles (capsule toner) can be obtained. As a process for covering with the polymer for shell, there is a process, in which a polymerizable monomer for forming a shell is added to the reaction liquid, from which the colored polymer particles have been obtained, and the polymerization reaction is successively continued. Besides, there is also a process, in which after colored polymer particles are obtained once, an optional polymer component is added to cause the polymer component to be adsorbed or stuck on the particles. Core•shell type polymer particles, in which colored polymer particles are formed from a softer material (for example, a material having a lower glass transition temperature) compared with the polymer for shell, are formed, whereby a capsule toner well balanced between low-temperature fixing ability and high-temperature storability can be provided.

After the polymerization or the covering with the polymer for shell, the colored polymer particles are washed, dehydrated and dried. The washing is desirably conducted by adopting a washing method capable of reducing the amount of metals (metal ions) remaining in the colored polymer particles as much as possible. If metals (ions) such as magnesium and calcium in particular remain in the colored polymer particles, they absorb moisture under high-humidity conditions, so that in some cases, the flowability of the resulting toner may be deteriorated, or image quality may be adversely affected. A polymerized toner low in the content (amount of remaining metals) of remaining metals such as magnesium and calcium remaining in the colored polymer particles can provide good-quality images high in printing density and free of fogging even under high-temperature and high-humidity conditions by a high-speed machine capable of printing at a printing rate of at least 30 sheets per minute. The amount of the remaining metals is preferably at most 500 ppm, more preferably at most 300 ppm, particularly preferably at most 200 ppm. In order to reduce the amount of the remaining metals, it is preferable to use a washing and dehydrating machine such as a continuous belt filter or a siphon peeler type centrifuge upon, for example, washing and dehydration of the colored polymer particles. After the washing step, the colored polymer particles in the wetted state are dried. The colored polymer particles after the drying may be classified as needed. According to the production process of the present invention, however, colored polymer particles having an extremely sharp particle diameter distribution can be obtained without arranging a classification step.

The colored polymer particles obtained by the production process according to the present invention are substantially spherical, and the volume average particle diameter dv thereof is generally 1 to 20 μm, preferably 2 to 15 μm, more preferably 3 to 10 μm. In order to obtain a definite and vivid image, it is preferable to control the volume average particle diameter of the colored polymer particles within a range of 4 to 8 μm.

The particle diameter distribution represented by a ratio dv/dp of the volume average particle diameter dv to the number average particle diameter dp of the colored polymer particles is generally 1 to 1.5, preferably 1 to 1.4, more preferably 1 to 1.3, particularly preferably 1 to 1.2. A value Sc/Sr obtained by dividing an area Sc of a circle supposing that the absolute maximum length of the particle is a diameter by a substantial projected area Sr of the particle generally falls within a range of 1 to 1.3. A product (A×dp×D) of the BET specific surface area (A) [m²/g], the number average particle diameter (dp) [μm] and the true specific gravity (D) desirably falls within a range of 5 to 10.

Particularly preferred colored polymer particles are such that the melt viscosity thereof is generally at most 100,000 Pa·s, preferably 100 to 50,000 Pa·s, more preferably 1,000 to 30,000 Pa·s. The viscosity measurement may be conducted by means of a flow tester. The use of the polymerized toner having such a melt viscosity permits realizing high image quality even in high-speed printing.

The colored polymer particles (including core•shell type colored polymer particles) may also be used as a polymerized toner in development as they are. However, they are preferably subjected to a treatment with additives. By the treatment with additives, the additives (hereinafter referred to as “external additives”) are cause to adhere to or embed into the surfaces of the colored polymer particles, whereby the charging property, flowability, storage stability and the like thereof are adjusted.

As the external additives, may be mentioned inorganic particles, particles of organic acid salts and organic resin particles. Examples of the inorganic particles include silicon dioxide, aluminum oxide, titanium oxide, zinc oxide, tin oxide, barium titanate and strontium titanate. Examples of the particles of the organic acid salts include zinc stearate and calcium stearate. Examples of the organic resin particles include particles of methacrylic ester polymers, acrylic ester polymers, styrene-methacrylic ester copolymers and styrene-acrylic ester copolymers, and core-shell type particles in which the shell is composed of a methacrylic ester polymer, and the core is composed of a styrene polymer. Among these, the inorganic particles, particularly, silicon dioxide particles are preferred. The surfaces of these particles may be subjected to a hydrophobicity-imparting treatment, and silicon dioxide particles subjected to the hydrophobicity-imparting treatment are particularly preferred.

No particular limitation is imposed on the amount of the external additive added. However, it is generally 0.1 to 6 parts by weight per 100 parts by weight of the colored polymer particles. Two or more of the external additives may be used in combination. When the external additives are used in combination, it is preferable to use two or more kinds of inorganic particles or inorganic particles and organic resin particles, which are different in average particle diameter from each other, in combination. The adhesion of the external additives to the colored polymer particles is generally conducted by charging them into a mixer such as a HENSCHEL MIXER to mix them.

### EXAMPLES

The present invention will hereinafter be described more specifically by the following examples and comparative examples. However, the present invention is not limited to these examples only. All designations of “part” or “parts” and “%” as will be used in the following examples mean part or parts by weight and % by weight unless expressly noted. In the present invention, the measuring or determining methods of physical properties and properties or characteristics are as follows.

(1) Surface Roughness of Inner Wall of Polymerization Container:

A surface roughness meter [manufactured by Shiro Sangyo K.K., trade name “SE-35A”] was used to measure a surface roughness Ry defined in JIS B 0601 in an inner wall of a polymerization container at 16 places in total of 4 places (i.e., 3×4=12 places) uniformly divided on circumferences of 3 positions at equal intervals in a depth direction and 4 places uniformly divided on a circumference of half a diameter of the bottom, thereby finding an average value. Any measuring place was determined so as to be under the liquid level when an aqueous liquid dispersion was poured into the polymerization container.

(2) Droplet Diameter of Droplets of Polymerizable Monomer Composition:

the volume average droplet diameter dv and droplet diameter distribution represented by a ratio dv/dp of the volume average droplet diameter dv to the number average droplet diameter dp of droplets of a polymerizable monomer composition in an aqueous dispersion medium were measured by means of a particle diameter distribution meter (manufactured by Shimadzu Corporation, trade name “SALD 2000A Model”). The measurement of the droplet diameter distribution was conducted under conditions that a refractive index was 1.55 to 0.20 i and ultrasonic wave irradiation time was 5 minutes.

(3) Particle Diameter and Particle Diameter Distribution of Polymer Particles:

The volume average particle diameter dv and particle diameter distribution represented by a ratio dv/dp of the volume average particle diameter dv to the number average particle diameter dp of polymer particles were measured by means of a MULTISIZER (manufactured by Beckmann Coulter Co.). The measurement by the Multisizer was conducted under the following conditions:

Aperture diameter: 100 μm;

Medium: ISOTHONE;

Sample concentration: 10%; and

Number of particles measured: 100,000 particles.

(4) Polymerization Time:

The sum total of the time required until heating was initiated from room temperature (20° C.), and the temperature reached a target polymerization temperature, and the polymerization reaction time required until polymerization was completed after reaching the target polymerization temperature was regarded as polymerization time. In this time, the polymerization time of core and the polymerization time of shell are included.

(5) Amount of Scale:

After completion of a polymerization reaction, an aqueous liquid dispersion with colored polymer particles dispersed therein was transferred from a polymerization container to a slurry tank by means of a pump. After the transfer, aggregates remaining on the bottom of the polymerization container were recovered, and scale adhered to a wall surface and the like was then scraped off with water jet. After the scale scraped was collected, and both of the thus-obtained aggregated and scale were dried, the weight thereof was measured to regard it as a weight of scale. The weight of the scale obtained is referred to as A. The weight of the overall solid content calculated from a polymerization recipe (calculated from the weight of a raw material supposing that the reaction is completely ended to 100%) is referred to as B. The amount of scale was calculated out in accordance with an equation “amount of aggregates=(A/B)×100”.

(6) Fixing Ability (Fixing Temperature):

A commercially available printer (printing speed: 24 paper sheets per minute) of a non-magnetic one-component development system was modified in such a manner that the temperature of a fixing roll can be varied. This modified printer was used to vary the temperature of the fixing roll, thereby determining a fixing rate at each temperature to find a relationship between the temperature and the fixing rate. The temperature of the fixing roll, at which the fixing rate was 80%, was defined as a fixing temperature.

The fixing rate was calculated from a ratio of image densities before and after a rubbing test operation, which was conducted against a black solid-printed area of a test paper sheet, on which printing had been made by the printer. More specifically, assuming that the image density before the rubbing test is ID(before), and the image density after the rubbing test is ID(after), the fixing rate (%) is found by [ID(after)/ID(before)]×100. In this test, the black solid-printed area means an area controlled in such a manner that the developer is caused to adhere to all dots (which are virtual dots controlling a control part of the printer) within this area. The rubbing test operation is a series of operation that a measuring portion of the test paper sheet is applied to a fastness tester with a pressure-sensitive adhesive tape, a load of 500 g is placed thereon, and the measuring portion is reciprocatorily rubbed 5 times with a rubbing pad wrapped in a cotton cloth.

(7) Storability:

About 20 g of a toner was precisely weighed and placed in a closable container to seal it, and the container was then sunk into a constant-temperature water bath controlled to temperature of 55° C. The container was taken out of the constant-temperature water bath after 8 hours elapsed, and the toner in the container was transferred to a 42-mesh sieve. At this time, the toner was quietly taken out of the container so as not to destroy the aggregate structure of the toner, and carefully transferred to the sieve. After the sieve was vibrated for 30 seconds by means of a powder measuring device under conditions of a vibration width of 1 mm, the weight of the toner remaining on the sieve was measured to regard it as the weight of an aggregated toner. A proportion (% by weight) of the weight of the aggregated toner to the weight of the whole toner was calculated out. The measurement was conducted 3 times on one sample, and the average value thereof was used as an index to the storability.

(8) Printing Density:

After paper for printing was set in the above-described commercially available printer, a toner to be evaluated was charged into a developing device of this printer, and the printer was left to stand for a day under H/H environment of 35° C. in temperature and 80% in humidity, printing was continuously conducted from the beginning at a printing density of 5%, and solid printing was conducted upon printing on the 1,000-th paper sheet. With respect to the solid-printed paper sheet, the printing density was measured by means of a transmission type image density meter manufactured by McBeth Co.

(9) Measurement of MI Value:

A melt indexer (manufactured by Toyo Seiki Co., Ltd., trade name “Semi-auto Melt Indexer”) was used to weigh about 5 g of a toner to be measured, thereby conducting measurement under conditions of a temperature of 150° C. and a load of 10 kgf in accordance with JIS K 7210A. The measurement was conducted 3 times on one sample, and the average value thereof was regarded as an MI value.

### Example 1

1. Surface Roughness of Inner Wall of Polymerization Container:

An inner wall surface under a liquid level upon polymerization in a polymerization container was polished with Buff #300 and additionally electrolyticly polished to adjust its surface roughness Ry to 0.3 μm on the average.

2. Preparation of Polymerizable Monomer Composition:

A polymerizable monomer (calculated Tg=about 55° C.) composed of 83 parts of styrene, 17 parts of n-butyl acrylate, 0.6 parts of divinylbenzene and 0.25 parts of a polymethacrylic ester macromonomer (product of Toagosei Chemical Industry Co., Ltd., trade name “AA6”, Tg=94° C.;), 7 parts of carbon black (product of Mitsubishi Chemical Corporation, trade name “#25”), 1 part of a charge control resin (product of Fujikura Kasei Co., Ltd., trade name “FCA207P”; styrene/acrylic resin containing 2% of a quaternary ammonium salt group-containing (meth)acrylate monomer), and 1.8 parts of t-dodecylmercaptan were stirred and mixed. Thereafter, the respective components were uniformly dispersed in the polymerizable monomer by means of a media type dispersing machine. Additionally, 6 parts of dipentaerythritol hexamyristate (solubility in styrene at 25° C.=at least 10 g/100 g, endothermic peak temperature=65° C., molecular weight=1,514) was added, mixed and dissolved to obtain a polymerizable monomer composition. The preparation of the polymerizable monomer composition was conducted at room temperature throughout this process.

3. Preparation of First Aqueous Dispersion Medium (A1):

An aqueous solution with 6.6 parts of sodium hydroxide dissolved in 35 parts of ion-exchanged water was gradually added to an aqueous solution with 10.8 parts of magnesium chloride dissolved in 215 parts of ion-exchanged water under stirring to prepare an aqueous dispersion medium containing magnesium hydroxide colloid (colloid of hardly water-soluble metal hydroxide). One part of sodium tetraborate decahydrate was additionally added to this aqueous dispersion medium. The preparation of this aqueous dispersion medium was conducted at room temperature throughout this process. The particle diameter distribution of the colloid was measured by means of an SALD particle diameter distribution meter (manufactured by Shimadzu Corporation). As a result, the particle diameter was found to be 0.36 μm in terms of D₅₀ (50% cumulative value of number particle diameter distribution) and 0.85 μm in terms of D₉₀ (90% cumulative value of number particle diameter distribution).

4. Droplet-Forming Step:

The polymerizable monomer composition was poured into the above-obtained aqueous dispersion medium containing the magnesium hydroxide colloid at room temperature, and the resultant mixture was stirred until droplets (primary droplets) became stable. After 5 parts of t-butyl peroxy-2-ethylhexanoate (product of Nippon Oil & Fats Co., Ltd., trade name “PERBUTYL O”) was then added as a polymerization initiator, the resultant dispersion was stirred under high shearing 30 minutes at 15,000 rpm by means of an EBARA MILDER (manufactured by Ebara Corporation) to form fine droplets (secondary droplets) of the polymerizable monomer composition.

5. Preparation of Second Aqueous Dispersion Medium (A2):

An aqueous solution with 0.92 part of sodium hydroxide dissolved in 7.93 parts of ion-exchanged water was gradually added to an aqueous solution with 1.51 parts of magnesium chloride dissolved in 39.64 parts of ion-exchanged water under stirring to prepare 50 parts of a second aqueous dispersion medium containing magnesium hydroxide colloid.

6. Spraying of Second Aqueous Dispersion Medium (A2):

A shower nozzle having ejection orifices each having a diameter of 1 mm was arranged at an upper portion of the polymerization container. Fifty parts of the second aqueous dispersion medium was sprayed from the upper portion in the polymerization container through this shower nozzle. The second aqueous dispersion medium sprayed wetted the inner wall of the polymerization container and the surface of an agitating blade and left at a lower portion of the polymerization container.

7. Heating and Polymerization:

An agitating blade was installed in the polymerization container the surface roughness Ry of the inner wall surface of which was 0.3 μm. The aqueous liquid dispersion of the polymerizable monomer composition with the droplets formed therein was poured into this polymerization container. This aqueous liquid dispersion was heated to raise the temperature of the aqueous liquid dispersion from room temperature to 85° C. at a heating rate of 40° C./hr on the average, and raise it from 85° C. to 90° C. at a heating rate of 15° C./hr on the average and finally raise the temperature of the aqueous liquid dispersion to a target polymerization temperature, 90° C.

The temperature of the aqueous liquid dispersion was controlled by measuring the temperature of a jacket arranged around the polymerization container and the temperature of the aqueous liquid dispersion (polymerization reaction liquid) and control the jacket temperature using the cascade control method, thereby realizing the above-described heating pattern. After the temperature of the aqueous liquid dispersion reached 90° C., the temperature of the aqueous liquid dispersion was controlled so as to undergo a transition between 88° C. and 91° C., thereby conducting polymerization for 8 hours under stirring.

8. Preparation of Aqueous Liquid Dispersion of Polymerizable Monomer for Shell:

At room temperature, 0.7 part of methyl methacrylate (calculated Tg=105° C.) and 10 parts of water were subjected to a finely dispersing treatment by an ultrasonic emulsifier to obtain an aqueous liquid dispersion of a polymerizable monomer for shell. The droplet diameter of droplets of the polymerizable monomer for shell was measured by means of a microtrack particle diameter distribution meter (manufactured by Nikkiso Co., Ltd.) by adding the droplets thus obtained at a concentration of 3% into a 1% aqueous solution of sodium hexametaphosphate. As a result, D₉₀ was 1.6 μm.

9. Polymerization of Shell:

After confirming that a polymerization conversion into core particles reached almost 100%, sampling was conducted to measure the particle diameter of colored polymer particles formed. As a result, the volume average particle diameter dv of the colored polymer particles was 6.4 μm, and a ratio of the volume average particle diameter dv to the number average particle diameter dp was 1.18.

The aqueous liquid dispersion of the polymerizable monomer for shell and a solution with 0.07 part of a water-soluble initiator (product of Wako Pure Chemical Industries, Ltd., trade name “VA086”) dissolved in 10 parts of distilled water were placed in the polymerization container. After the polymerization was continued for 3 hours, the reaction was stopped to obtain an aqueous liquid dispersion (slurry) containing core•shell type colored polymer particles and having a pH of 9.5.

10. Water Spraying:

Water was continuously sprayed at a rate of 1 liter/min from the beginning of polymerization of the core particles (after the temperature of the aqueous liquid dispersion reached 90° C.) up to the time the conversion into the shell polymer had reached almost 100%, and the spraying was stopped at the time the conversion into the polymer had reached 100%.

The above-obtained reaction liquid containing the core-shell type colored polymer particles was discharged, aggregates precipitated on the bottom of the polymerization container were taken out, and scale adhered to the wall of the polymerization container and the agitator were washed off by water jet to collect the aggregates and scale. They were dried and then weighed. The amount of the scale in the first polymerization reaction alone was 1.0%.

The same polymerization container was used to conduct the same polymerization reaction continuously 5 times (referred to as 5-batch continuous polymerization). In each batch, no scale was removed. The amount of scale deposited throughout the 5-batch continuous polymerization was 2.6%. Incidentally, the amount of the scale after the 5-batch continuous polymerization is a value calculated out from the weight of the scale measured in the fifth batch (fifth time) and the weight of the whole solid content calculated out from the polymerization formulation of one batch.

11. Collecting Step:

While stirring the slurry containing the colored polymer particles formed at room temperature, acid washing that the pH of the system is adjusted to 4.0 or lower was conducted with sulfuric acid. After water was separated by filtration, 500 parts of ion-exchanged water was newly added to prepare a slurry again, thereby conducting water washing. Thereafter, dehydration and water washing were conducted again several times repeatedly at room temperature, and solids were separated by filtration and then dried at 45° C. for a day by a dryer to obtain colored polymer particles having a core•shell type structure.

12. Colored Polymer Particles:

The volume average particle diameter dv of the thus-obtained colored polymer particles was 6.4 μm, and a ratio of the volume average particle diameter dv to the number average particle diameter dp was 1.18. The thickness of the shell calculated out from the amount of the polymerizable monomer for shell and the particle diameter of the core particles was 0.03 μm. The spheroidicity (Sc/Sr) of the colored polymer particles was 1.20. The amount of gel was 56%.

The same polymerization container was used to continuously conduct a polymerization reaction 5 times in the same manner as it is, thereby producing colored polymer particles (5-batch continuous polymerization). The volume average particle diameter dv of colored polymer particles obtained in the fifth batch (fifth time) was 6.5 μm, a ratio of the volume average particle diameter dv to the number average particle diameter dp was 1.19, and the amount of gel was 55%.

13. Polymerized Toner:

To 100 parts of the core•shell type colored polymer particles obtained above, was added 0.6 part of colloidal silica (product of Nippon Aerosil Co., Ltd., trade name “RX300”) subjected to a hydrophobicity-imparting treatment at room temperature, and the resultant mixture was stirred by means of a Henschel mixer to prepare a toner (non-magnetic one-component developer). The toner thus obtained was used to make evaluation as to image. As a result, an image high in the printing density of the resultant toner, free of fog and irregularities and extremely good in resolution was obtained.

The properties and polymerization time of the toner obtained in the first time are shown in Table 1. Besides, the same polymerization container was used to conduct the same polymerization reaction continuously 5 times (5-batch continuous polymerization), and the properties and polymerization time of a toner obtained in the fifth batch (fifth time) are also shown in Table 1.

### Comparative Example 1

A polymerization reaction was conducted in the same manner as in Example 1 except that a polymerization container, the surface roughness Ry of the inner wall of which was 4 μm, was used. The results are shown in Table 1.

### Comparative Example 2

A polymerization reaction was carried out in the same manner as in Example 1 except that the heating rate upon the polymerization in Example 1 was changed as shown in Table 1. The results are shown in Table 1.

TABLE 1

| | Example | Comp. Example | |
|---|---|---|---|
| | 1 | 1 | 2 |
| Polymerization conditions | | | |
| Surface roughness Ry of polymerization | 0.3 | 4 | 0.3 |
| container (μm) | | | |
| Heating rate (room temperature-85° C.) | 40 | 40 | 65 |
| (° C./h) | | | |
| Heating rate (85-90° C.) (° C./h) | 15 | 15 | 25 |
| Times of continuous polymerization | 5 | 5 | 5 |
| Polymerized toner | | | |
| First time | | | |
| Volume average particle diameter dv | 6.4 | 6.9 | 6.5 |
| (μm) | | | |
| Particle diameter distribution dv/dp | 1.18 | 1.25 | 1.19 |
| Amount of gel | 56 | 58 | 52 |
| Fifth time (after 5-batch continuous | | | |
| polymerization) | | | |
| Volume average particle diameter dv | 6.5 | 7.1 | 6.8 |
| (μm) | | | |
| Particle diameter distribution dv/dp | 1.19 | 1.32 | 1.24 |
| Amount of gel (%) | 55 | 59 | 51 |
| Polymerization time (heating time + | | | |
| reaction time) | | | |
| First time | 13.0 | 13.0 | 12.0 |
| Fifth time (after 5-batch continuous | 13.5 | 15.5 | 18.0 |
| polymerization) | | | |
| Amount of scale (% by weight) | | | |
| First time | 1.0 | 3.7 | 4.8 |
| Fifth time (after 5-batch continuous | 2.6 | 12.4 | 15.1 |
| polymerization) | | | |
| Fixing temperature (° C.) | | | |
| First time | 190 | 200 | 170 |
| Fifth time (after 5-batch continuous | 180 | 190 | 160 |
| polymerization) | | | |
| Storability (%) | | | |
| First time | 0.5 | 0.2 | 1.2 |
| Fifth time (after 5-batch continuous | 0.6 | 2.1 | 4.6 |
| polymerization) | | | |
| Printing density | | | |
| First time | 1.42 | 1.41 | 1.44 |
| Fifth time (after 5-batch continuous | 1.44 | 1.56 | 1.65 |
| polymerization) | | | |
| MI value 150° C. × 10 kg) | | | |
| First time | 4.2 | 3.5 | 16 |
| Fifth time (after 5-batch continuous | 5.6 | 10.2 | 36 |
| polymerization) | | | |

As apparent from the results shown in Table 1, according to the production process (Example 1) of the present invention, the polymerization time is short, and the amount of scale produced is small even after the 5-batch continuous polymerization. In addition, a high-quality polymerized toner stable in fixing ability, storability, printing density and MI value can be obtained.

On the other hand, when the polymerization container, the surface roughness Ry of the inner wall of which is great, is used (Comparative Example 1), the polymerization time lengthens, and the amount of scale produced becomes great after the 5-batch continuous polymerization. In addition, scattering of fixing ability, storability, printing density, MI value, etc. becomes wide, and the quality of the polymerized toner is deteriorated.

When the heating rate is made too fast (Comparative Example 2), the amount of scale produced becomes great, and the polymerization time markedly lengthens after the 5-batch continuous polymerization. In addition, scattering of fixing ability, storability, printing density, MI value, etc. becomes wide, and the quality of the polymerized toner is deteriorated.

### INDUSTRIAL APPLICABILITY

According to the production process of the present invention, the amount of scale adhered to an inner wall of a polymerization container is markedly reduced, and the polymerization time can be greatly shortened even when the heating rate of an aqueous liquid dispersion containing a polymerizable monomer composition is accelerated. In addition, a polymerized toner narrow in scattering of toner properties every production lot can be stably produced.

According to the present invention, the corrosion-resistant metal container is used as the polymerization container, so that the lowering of the thermal conductivity of its inner wall due to a lining treatment can be avoided.

The polymerized toners obtained by the production process according to the present invention can be utilized as developers for making an electrostatic latent image formed on a photosensitive member visible in image forming apparatus of an electrophotographic system or electrostatic recording system, such as copying machines, laser beam printers and facsimiles.

1. A production process of a polymerized toner, comprising Step 1 of forming droplets of a polymerizable monomer composition containing a polymerizable monomer, a colorant and a polymerization initiator in an aqueous dispersion medium containing a dispersion stabilizer to prepare an aqueous liquid dispersion with the droplets dispersed therein, and Step 2 of heating the aqueous liquid dispersion in a polymerization container to polymerize the polymerizable monomer composition, thereby forming colored polymer particles,
wherein in Step 2,
(1) a corrosion-resistant metal container, the surface roughness Ry of an inner wall of which is at most 3 μm, is used as the polymerization container, and
(2) upon the heating of the aqueous liquid dispersion in the polymerization container to conduct polymerization,
i) the temperature of the aqueous liquid dispersion is raised up to a temperature 5° C. lower than a target polymerization temperature at a heating rate of 20 to 60° C./hr,
ii) the temperature of the aqueous liquid dispersion is raised up to the target polymerization temperature from the temperature 5° C. lower than the target polymerization temperature at a heating rate of 5 to 30° C./hr, and
iii) after the temperature of the aqueous liquid dispersion reaches the target polymerization temperature, a polymerization reaction is carried out while controlling the temperature of the aqueous liquid dispersion so as to fall within a range of (the target polymerization temperature ±3° C.).

2. The production process according to claim 1, wherein in Step 1, the droplets of the polymerizable monomer composition are formed in a first aqueous dispersion medium (A1) containing the dispersion stabilizer to prepare an aqueous liquid dispersion with the droplets dispersed therein, and in Step 2, a second aqueous dispersion medium (A2) containing 0.1 to 5% by weight of the dispersion stabilizer is poured into the aqueous liquid dispersion thus obtained in a proportion of 10 to 150 parts by weight per 100 parts by weight of the polymerizable monomer prior to initiation of the heating.

3. The production process according to claim 1, wherein in Step 2, water is sprayed during the polymerization to retain an upper inner wall surface of the polymerization container in a wetted state.

4. The production process according to claim 1, wherein the corrosion-resistant metal container is a stainless steel container.

5. The production process according to claim 4, wherein the stainless steel container is an austenitic stainless steel container.

6. The production process according to claim 1, wherein the surface roughness Ry of the inner wall of the polymerization container is at most 1 μm.

7. The production process according to claim 1, wherein the surface roughness Ry of the inner wall of the polymerization container is at most 0.5 μm.

8. The production process according to claim 1, wherein the polymerization container is a corrosion-resistant metal container, the surface roughness Ry of the inner wall of which is controlled to at most 3 μm by buff polishing, electrolytic polishing or a combination thereof.

9. The production process according to claim 1, wherein in Step 1, the temperature of the aqueous liquid dispersion is controlled within a range of 10 to 40° C.

10. The production process according to claim 1, wherein in Step 2, the temperature of the aqueous liquid dispersion is raised up to the temperature 5° C. lower than the target polymerization temperature at a heating rate of 25 to 50° C./hr.

11. The production process according to claim 1, wherein in Step 2, the temperature of the aqueous liquid dispersion is raised up to the target polymerization temperature from the temperature 5° C. lower than the target polymerization temperature at a heating rate of 10 to 20° C./hr.

12. The production process according to claim 1, wherein in Step 2, the target polymerization temperature is determined to be within the range of ±2° C. from hourly half-life temperature.

13. The production process according to claim 1, wherein the dispersion stabilizer is colloid of a hardly water-soluble metal hydroxide.

14. The production process according to claim 1, wherein in Step 2, the polymerization is conducted until a conversion into a polymer reaches substantially 100%.

15. The production process according to claim 1, wherein in Step 2, the temperature of a jacket arranged at an outer periphery of the polymerization container and the temperature of the aqueous liquid dispersion are measured to make temperature control using a cascade control method.

16. The production process according to claim 1, which comprises a step of adding a polymerizable monomer for shell to the aqueous liquid dispersion containing the colored polymer particles formed after Step 2 to further conduct polymerization, thereby forming a shell polymer on the surfaces of the colored polymer particles to form core-shell type colored polymer particles.

17. The production process according to claim 1, wherein the colored polymer particles are substantially spherical, the volume average particle diameter dv thereof is 3 to 10 μm, and a particle diameter distribution represented by a ratio dv/dp of the volume average particle diameter dv to the number average particle diameter dp is 1 to 1.2.

18. The production process according to claim 16, wherein the core-shell type colored polymer particles are substantially spherical, the volume average particle diameter dv thereof is 3 to 10 μm, and a particle diameter distribution represented by a ratio dv/dp of the volume average particle diameter dv to the number average particle diameter dp is 1 to 1.2.
